(19) United States
(12) Patent Application Publication
(10) Pub. No.: US 2008/0017334 A1
(43) Pub. Date: Jan. 24, 2008

(54) Pop off nipple snap on fastener for sun shade technology

(76) Inventor: Boney A. Mathew, Clarkston, MI (US)

Correspondence Address: DICKINSON WRIGHT PLLC, 38525 WOODWARD AVENUE, SUITE 2000, BLOOMFIELD HILLS, MI, 48304-2970, US

(21) Appl. No.: 11/701,253

(22) Filed: Feb. 1, 2007

Related U.S. Application Data
(60) Provisional application No. 60/832,879, filed on Jul. 24, 2006.

(51) Int. Cl. B60J 3/00; A44B 17/00; F16B 21/00

(52) U.S. Cl. 160/370.21; 24/459; 411/511

(57) ABSTRACT

The subject invention includes a plurality of projections (46) for sandwiching fabric (42) between inner and outer members (22, 24). Each of the projections (46) extends laterally from the inner member (22) to a distal rim (48) and defines a hollow passageway (50). The outer member (24) defines a plurality of circular holes (58) having a hole diameter (E) for receiving the projections (46) and maintaining the members (22, 24) in a clamping engagement with the fabric (42). The projections (46) define a cylindrical exterior surface (54) extending from the inner member (22) and having an outer diameter (B). A nipple ridge (56) projects radially from the exterior surface (54) of each of the projections (46) to a ridge diameter (A), which is larger than the outer diameter (B) and snaps into a recessed shelf (62) disposed about the holes (58) on the outer member (24) retain the projections (46) in the holes (58).

### CROSS REFERENCE TO RELATED APPLICATION

This application claims the benefit of provisional application Ser. No. 60/832,879 filed Jul. 24, 2006.

### BACKGROUND OF THE INVENTION

1. Field of the Invention

The subject invention relates to a sun shade assembly for an automotive window, and more specifically to an inner member and an outer member for sandwiching fabric between the inner and outer members.

2. Description of the Prior Art

Generally, snap together connections are well known where a male projection snaps into a female hole. Many of the male projections are solid thus requiring a flexible hole. The U.S. Pat. No. 5,940,942 discloses a solid projection having a nipple ridge for interlocking with a flexible hole. The flexible hole includes “finger projections” that surround the inner opening of the hole, allowing for bending as the projection is pushed through the hole. Once the solid projection is through the hole, the nipple ridge and finger projections prevent the solid projection from moving.

U.S. Pat. No. 4,757,662 discloses a flexible projection and a solid hole. The projection is divided into a plurality of segments for locking a material in place. The segments, being evenly spaced around a circular base, bend closer together as the projection is pushed through the hole. Once the projection is through the hole, the segments return to their original spacing and the nipple ridge locks in the hole preventing the projection from moving.

### SUMMARY OF THE INVENTION AND ADVANTAGES

The subject invention provides for a plurality of tubular projections each extending laterally from the inner member to a distal rim and defining a hollow passageway extending from the distal rim through the inner member. The outer member defines a plurality of circular holes having a hole diameter for receiving the projections for maintaining the members in a clamping engagement with the fabric. Each of the projections defines a cylindrical exterior surface extending from the inner member and having an outer diameter. A nipple ridge projects radially outwardly from the exterior surface of each of the projections at the distal rim to a ridge diameter, such that the ridge diameter is larger than the outer diameter of the exterior surface. The invention is distinguished by the outer member including a recessed shelf disposed about and extending radially from each of the holes on the outer member for receiving the nipple ridges of the projections and further for retaining the projections in the holes.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of the outer member of the finisher;

FIG. 2 is a perspective view of the inner member of the finisher;

FIG. 3 is a cross sectional view of the projections;

FIG. 4 is a cross sectional view of the finisher and projections interlocking with the hole; and

FIG. 5 is a perspective view of the finisher holding fabric.

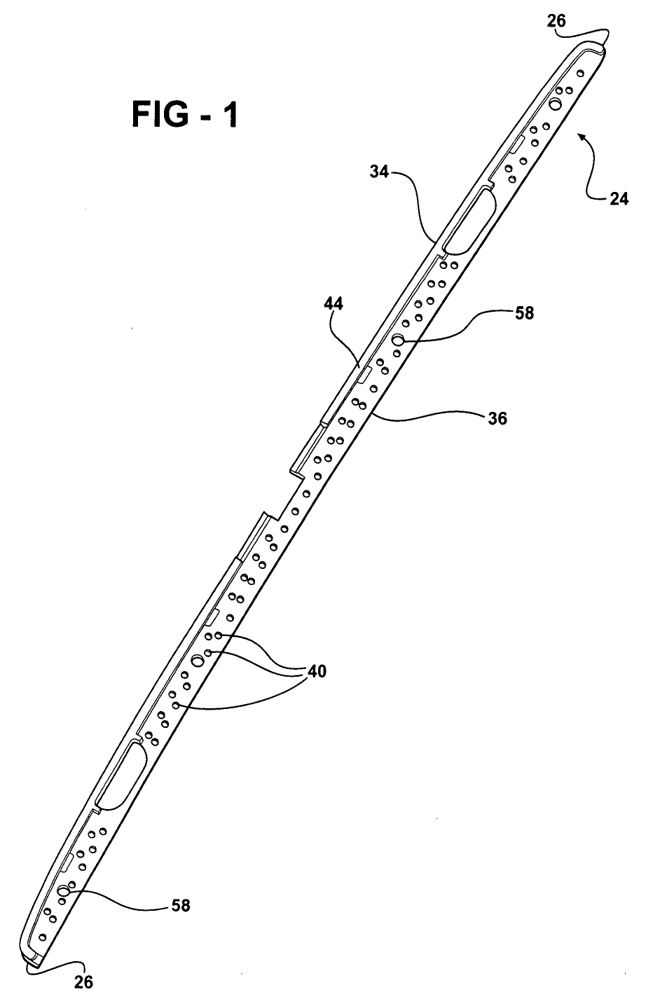

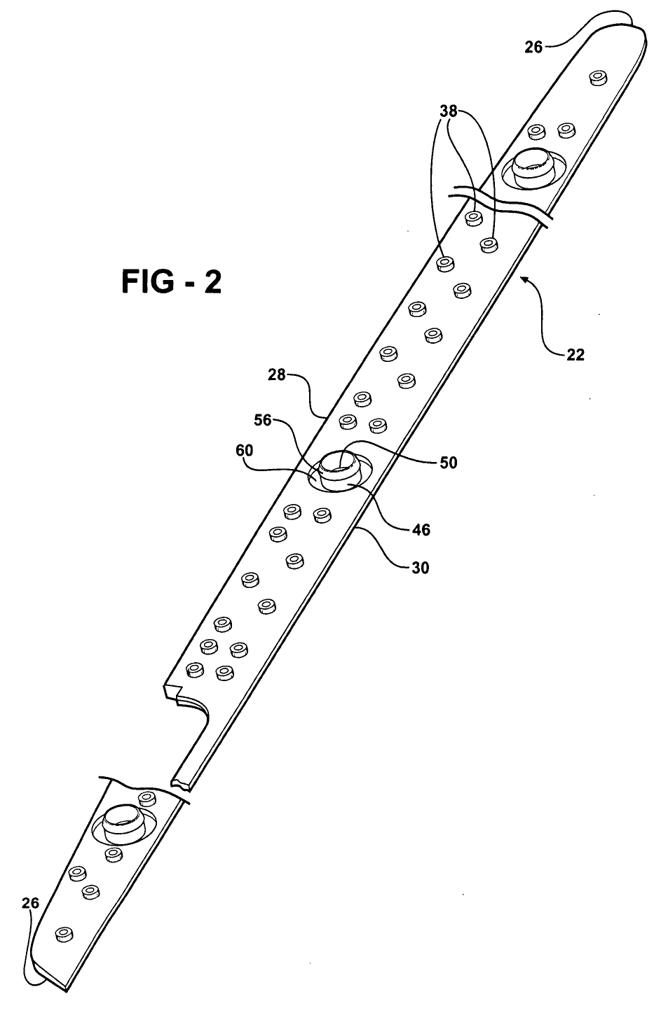

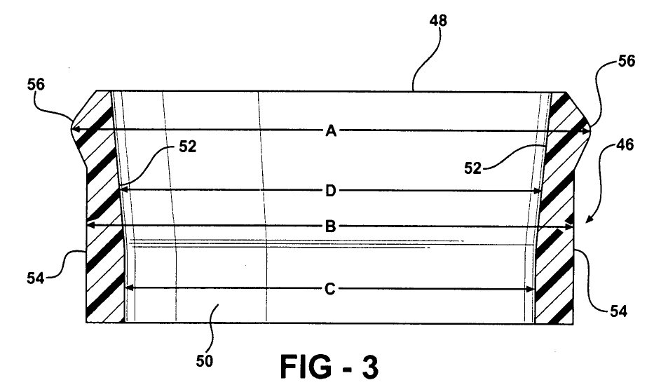

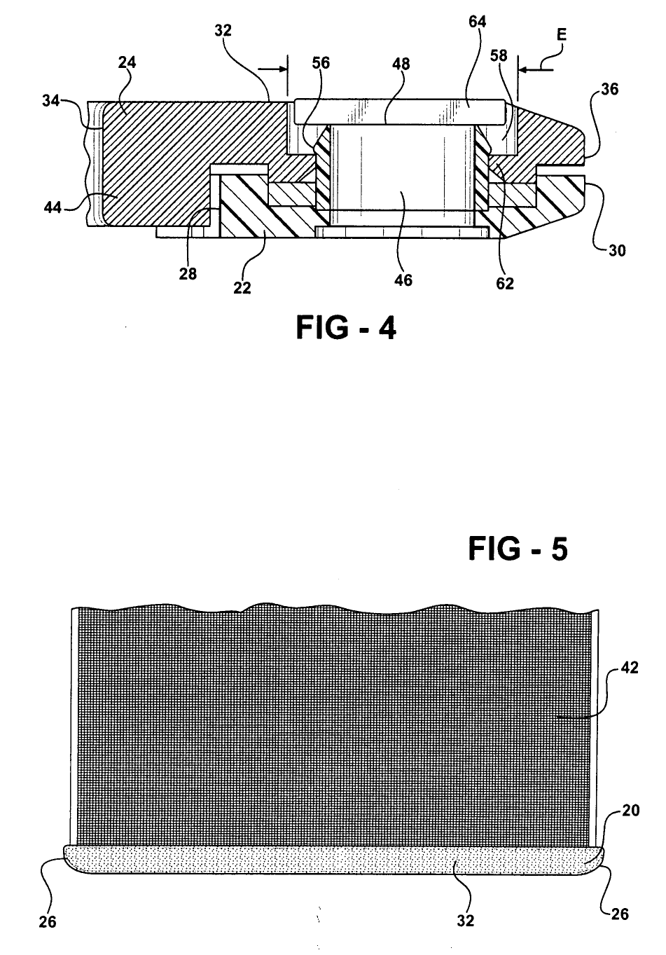

### DETAILED DESCRIPTION OF THE INVENTION

Referring to the Figures, wherein like numerals indicate corresponding parts throughout the several views, a connector is shown generally for an automotive sun shade technology. The sun shade technology includes a finisher 20 (generally shown) having an inner member 22 and an outer member 24 (both generally indicated) for interlocking with each other. The inner member 22 and the outer member 24 both extend longitudinally between two ends 26.

The inner member 22 has an inner top edge 28 and an inner bottom edge 30 extending between the ends 26 thereof and presenting opposite faces. The outer member 24 presents opposite faces, one of which defines an outer surface 32, extending between an outer top edge 34 and an outer bottom edge 36. The ends 26 of the members 22, 24 are curved between the top edges 28, 34 and the bottom edges 30, 36 of the inner and outer members 22, 24.

A plurality of male posts 38 extend laterally from and are disposed between the inner edges 30, 28 of the inner member 22. A plurality of female recesses 40, disposed between the outer edges 36, 34 of the outer member 24, extend into the outer member 24 for receiving the male posts 38 of the inner member 22. In other words, the posts 38 located on the inner member 22 align with and fit into the recesses 40 of the outer member 24.

A fabric 42 is sandwiched between the inner member 22 and the outer member 24. The fabric 42 can include solid flexible material, net-like material, and any form practical for the disclosed invention for acting as a sun shade. The fabric 42 is disposed on the inner member 22 and extends from the inner top edge 28 and through the inner bottom edge 30. Accordingly, the finisher 20 holds the fabric 42 so that it extends through the bottom edges 30, 36 of the finisher 20 for covering a window. The male posts 38 are pressed into the recesses 40 to hold the fabric 42 in the recesses 40. This creates friction and allows the fabric 42 to be held in place.

A flange 44 extends laterally from the outer top edge 34 and protrudes inwardly to overlap the inner top edge 28 of the outer member 24.

The invention is characterized by a plurality of tubular projections 46 each extending laterally from the inner member 22 to a distal rim 48 and defining a passageway 50 extending from the distal rim 48 through the inner member 22. The passageway 50 in each of the projections 46 has an inner diameter C and also includes a conically shaped taper 52 having a taper diameter D at the distal rim 48. The taper diameter D tapers inwardly to the inner diameter C, creating a gradually decreasing taper diameter D from the distal rim 48 to the inner member 22. In other words, the taper 52 presents a frusto-conical female surface between the rim and the diameter C.

Each of the projections 46 defines an cylindrical exterior surface 54 which extends from the inner member 22. The exterior surface 54 has an outer diameter B. A nipple ridge 56, having a trapezoidal cross section, projects radially outwardly from the exterior surface 54 of each of the projections 46 at the distal rim 48 to a ridge diameter A. The ridge diameter A is larger than the outer diameter B of the exterior surface 54. The projections 46 and the members 22, 24 comprise a plastic material, with a glass filler in the plastic material.

The outer member 24 defines a plurality of circular holes 58, which have a hole diameter E for receiving the projections 46 and maintaining the members 22, 24 in a clamping engagement with the fabric 42. The exterior surface 54 of each of the projections 46 and the nipple ridge 56 are devoid of a parting line, i.e., a smooth surface within small and consistent tolerances, allowing for a tight and secure connection with the holes 58 of the outer member 24.

The inner member 22 includes a circular trough 60 disposed about and extending radially from each of the cylindrical exterior surfaces 32, 54 of the projections 46. The outer member 24 includes a recessed shelf 62 disposed about and extending radially from each of the holes 58 on the outer member 24. This shelf 62 receives the nipple ridges 56 of the projections 46 and retains the projections 46 in the holes 58.

This is accomplished in part by the ridge diameter A being greater than the hole diameter E. The taper 52 also allows for the nipple ridge 56 to be pressed through the hole 58 and expand into the recessed shelf 62 with the distal rim 48 of the projection 46 disposed flush with the outer surface 32 of the outer member 24. Although not necessary to the invention, the taper 52 aids the nipple ridge 56 in being pressed through the hole 58. A plug 64 is then disposed in the passageway 50 of each of the projections 46 to close the circular holes 58 flush with the outer surface 32, thus creating a smooth outer surface 32.

Obviously, many modifications and variations of the present invention are possible in light of the above teachings and may be practiced otherwise than as specifically described while within the scope of the appended claims. That which is prior art in the claims precedes the novelty set forth in the “characterized by” clause. The novelty is meant to be particularly and distinctly recited in the “characterized by” clause whereas the antecedent recitations merely set forth the old and well-known combination in which the invention resides. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

ELEMENT LIST

| Element Symbol | Element Name |
|---|---|
| 20 | finisher |
| 22 | inner member |
| 24 | outer member |
| 26 | ends |
| 28 | inner top edge |
| 30 | inner bottom edge |
| 32 | outer surface |
| 34 | outer top edge |
| 36 | outer bottom edge |
| 38 | male posts |
| 40 | female recesses |
| 42 | fabric |
| 44 | flange |
| 46 | projections |
| 48 | distal rim |
| 50 | passageway |
| 52 | taper |
| 54 | annular exterior surface |
| 56 | nipple ridge |
| 58 | circular holes |
| 60 | circular trough |
| 62 | recessed shelf |
| 64 | plug |
| A | ridge diameter |
| B | outer diameter |
| C | inner diameter |
| D | taper diameter |
| E | hole diameter |

What is claimed is:

1. A sun shade assembly for an automotive window comprising;
a finisher (20) having an inner member (22) and an outer member (24) for interlocking with each other,
said inner member (22) extending longitudinally between two ends (26),
said outer member (24) extending longitudinally between two said ends (26),
said inner member (22) having an inner top edge (28) and an inner bottom edge (30) extending between said ends (26) thereof,
said outer member (24) presenting an outer surface (32) and an outer top edge (34) and an outer bottom edge (36) extending between said ends (26),
said ends (26) being curved between said top edges (28, 34) and said bottom edges (30, 36),
a plurality of male posts (38) extending laterally from and disposed between said inner edges (30, 28) of said inner member (22),
a plurality of female recesses (40) extending into said outer member (24) and disposed between said outer edges (36, 34) of said outer member (24) for receiving said male posts (38) of said inner member (22),
a flange (44) extending laterally from said outer top edge (34) and protruding inwardly to overlap said inner top edge (28) of said outer member (24),
a fabric (42) sandwiched between said inner member (22) and said outer member (24),
said fabric (42) disposed on said inner member (22) and extending from said inner top edge (28) and through said inner bottom edge (30),
said posts (38) being pressed into said recesses (40) to hold said fabric (42) in said recesses (40),
characterized by
a plurality of tubular projections (46) each extending laterally from said inner member (22) to a distal rim (48) and defining a passageway (50) extending from said distal rim (48) through said inner member (22),
said passageway (50) in each of said projections (46) having an inner diameter (C),
said passageway (50) including a conically shaped taper (52) having a taper diameter (D) at said distal rim (48) and tapering inwardly to said inner diameter (C),
each of said projections (46) defining an cylindrical exterior surface (54) extending from said inner member (22) and having an outer diameter (B),
a nipple ridge (56) projecting radially outwardly from said exterior surface (54) of each of said projections (46) at said distal rim (48) to a ridge diameter (A) larger than said outer diameter (B) of said exterior surface (54),
said nipple ridge (56) having a trapezoidal cross section,
said exterior surface (54) of each of said projections (46) and said nipple ridge (56) being devoid of a parting line,
said projections (46) and said members (22, 24) comprising a plastic material,
a glass filler in said plastic material,
said outer member (24) defining a plurality of circular holes (58) having a hole diameter (E) for maintaining said members (22, 24) in clamping engagement with said fabric (42),
said inner member (22) including a circular trough (60) disposed about and extending radially from each of said cylindrical exterior surfaces (32, 54) of said projections (46),
said outer member (24) including a recessed shelf (62) disposed about and extending radially from each of said holes (58) on said outer member (24) for receiving said nipple ridges (56) of said projections (46) for retaining said projections (46) in said holes (58),
said ridge diameter (A) being greater than said hole diameter (E) for allowing said nipple ridge (56) to be pressed through said hole (58) and expanding into said recessed shelf (62) with said distal rim (48) disposed flush with said outer surface (32) of said outer member (24), and
a plug (64) disposed in said passageway (50) of each of said projections (46) to close said holes (58) flush with said outer surface (32).

2. A sun shade assembly for an automotive window comprising;
a finisher (20) having an inner member (22) and an outer member (24) for interlocking with each other,
a fabric (42) sandwiched between said inner member (22) and said outer member (24),
characterized by
a plurality of tubular projections (46) each extending laterally from said inner member (22) to a distal rim (48) and defining a passageway (50) extending from said distal rim (48) through said inner member (22),
said outer member (24) defining a plurality of circular holes (58) having a hole diameter (E) for receiving said projections (46) for maintaining said members (22, 24) in clamping engagement with said fabric (42),
each of said projections (46) defining a cylindrical exterior surface (54) extending from said inner member (22) and having an outer diameter (B),
a nipple ridge (56) projecting radially outwardly from said exterior surface (54) of each of said projections (46) at said distal rim (48) to a ridge diameter (A) larger than said outer diameter (B) of said exterior surface (54), and
said outer member (24) including a recessed shelf (62) disposed about and extending radially from each of said holes (58) on said outer member (24) for receiving said nipple ridges (56) of said projections (46) for retaining said projections (46) in said holes (58).

3. An assembly as set forth in claim 2 wherein said passageway (50) in each of said projections (46) has an inner diameter (C) and includes a conically shaped taper (52) having a taper diameter (D) at said distal rim (48) and tapers inwardly to said inner diameter (C).

4. An assembly as set forth in claim 2 wherein said exterior surface (54) of each of said projections (46) and said nipple ridge (56) are devoid of a parting line.

5. An assembly as set forth in claim 2 wherein said nipple ridge (56) has a trapezoidal cross section.

6. An assembly as set forth in claim 2 wherein said inner member (22) extends longitudinally between two ends (26) and said outer member (24) extends longitudinally between two said ends (26).

7. An assembly as set forth in claim 6 wherein said inner member (22) has an inner top edge (28) and an inner bottom edge (30) extending between said ends (26) thereof and said outer member (24) presents an outer surface (32) and has an outer top edge (34) and an outer bottom edge (36) extending between said ends (26) thereof.

8. An assembly as set forth in claim 7 wherein said fabric (42) is disposed on said inner member (22) and extends from said inner top edge (28) through said inner bottom edge (30).

9. An assembly as set forth in claim 7 including a plug (64) disposed in said passageway (50) of each of said projections (46) to close said circular holes (58) flush with said outer surface (32).

10. An assembly as set forth in claim 7 including a plurality of male posts (38) extending laterally from and disposed between said inner edges (30, 28) of said inner member (22).

11. An assembly as set forth in claim 10 including a plurality of female recesses (40) extending into said outer member (24) and disposed between said outer edges (36, 34) of said outer member (24) for receiving said male posts (38) of said inner member (22).

12. An assembly as set forth in claim 11 wherein said posts (38) are pressed into said recesses (40) to hold said fabric (42) in said recesses (40).

13. An assembly as set forth in claim 7 wherein said ridge diameter (A) being greater than said hole diameter (E) for allowing said nipple ridge (56) to be pressed through said hole (58) and expanding into said recessed shelf (62) with said distal rim (48) disposed flush with said outer surface (32) of said outer member (24).

14. An assembly as set forth in claim 6 wherein said ends (26) are curved between said top edges (28, 34) and said bottom edges (30, 36).

15. An assembly as set forth in claim 7 including a flange (44) extending laterally from said outer top edge (34) and protruding inwardly to overlap said inner top edge (28) of said outer member (24).

16. An assembly as set forth in claim 2 wherein said projections (46) and said members (22, 24) comprise a plastic material.

17. An assembly as set forth in claim 16 including a glass filler in said plastic material.
